(19) United States
(12) Patent Application Publication
(10) Pub. No.: US 2016/0093331 A1
(43) Pub. Date: Mar. 31, 2016

(54) VIDEO EDITING

(71) Applicant: Multimedia Image Solution Limited, Dublin 2 (IE)

(72) Inventors: Hui Deng, San Ramon, CA (US); Peng Yang, Hangzhou (CN); Chuanqun Mei, Hangzhou (CN); Kaixuan Mao, Dublin, CA (US)

(21) Appl. No.: 14/527,789

(22) Filed: Oct. 30, 2014

(30) Foreign Application Priority Data
Sep. 30, 2014 (CN) 201410521848.9

(51) Int. Cl. G11B 27/031

(52) U.S. Cl. CPC G11B 27/031

(57) ABSTRACT

A method to edit digital videos includes dividing a first digital video into digital video segments, presenting a graphical user interface to select the digital video segments, receiving one or more selections of one or more of the digital video segments through the graphical user interface, and saving a second digital video with the selected digital video segments.

### BACKGROUND

The traditional way to edit a video in video editing software is through a timeline graphical user interface. To trim the video, a user sets new start and end points on the timeline. To split the video, the user sets a point in the timeline to split the video into two. However there is no easy way to use the timeline to remove multiple portions of the video.

### BRIEF DESCRIPTION OF THE DRAWINGS

In the drawings:

FIG. 1 is a block diagram of a computing device with a digital video editor in examples of the present disclosure;

FIG. 2 is a block diagram of a method performed by the digital video editor of FIG. 1 to edit digital videos in examples of the present disclosure; and

FIG. 3 is a graphical user interface of the digital video editor of FIG. 1 in examples of the present disclosure.

Use of the same reference numbers in different figures indicates similar or identical elements.

### DETAILED DESCRIPTION

As used herein, the term “includes” means includes but not limited to, the term “including” means including but not limited to. The terms “a” and “an” are intended to denote at least one of a particular element. The term “based on” means based at least in part on. The term “or” is used to refer to a nonexclusive such that “A or B” includes “A but not B,” “B but not A,” and “A and B” unless otherwise indicated.

In examples of the present disclosure, a digital video editor has an intuitive graphical user interface (GUI) to edit digital videos. The digital video editor divides a digital video into digital video segments. The GUI includes checkboxes (or similar elements) for the digital video segments. To merge different digital video segments together, a user selects checkboxes corresponding to desired digital video segments and the digital video editor generates a new digital video with the desired digital video segments.

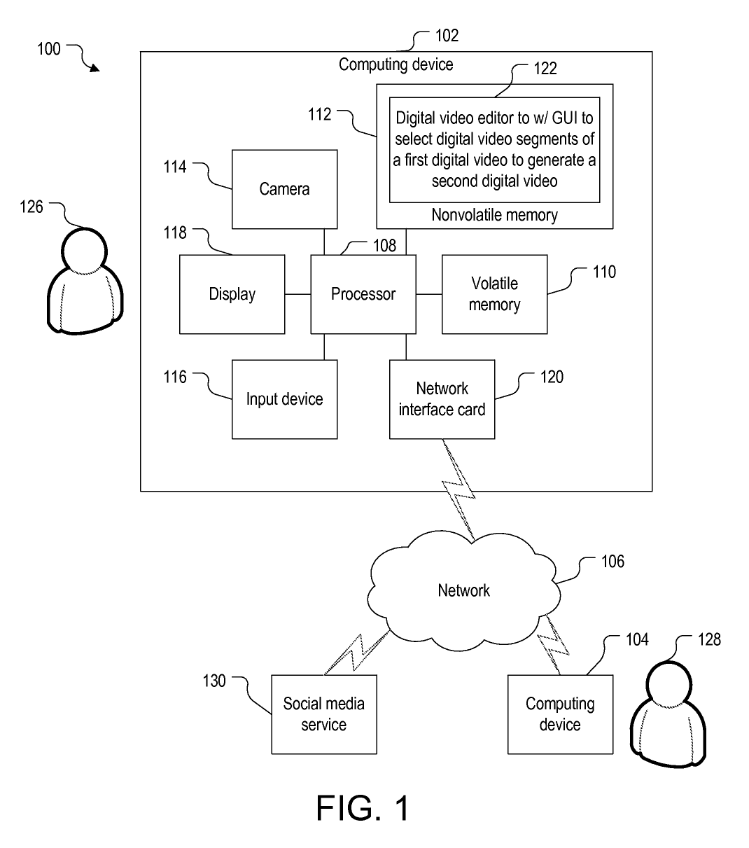

FIG. 1 is a block diagram of a computing device 102 with a digital video editor 122 having an intuitive GUI to edit digital videos in examples of the present disclosure. Computer device 102 may be a mobile phone, a tablet computer, a laptop computer, a desktop computer, a smart television, a set-top box.

Computing device 102 includes a processor 108, a volatile memory 110, a nonvolatile memory 112, a camera 114, an input device 116, a display 118, and a wired or wireless network interface card (NIC) 120. Nonvolatile memory 112 stores the code of digital video editor 122. Processor 108 loads the code of digital video editor 122 from nonvolatile memory 112 to volatile memory 110, executes the code, and stores application data in volatile memory 110. Camera 114 may be used to capture a digital video to be edited by digital video editor 122. Input device 116 may be a mouse, a touchpad, a touchscreen, or a keyboard used to interact with the GUI of digital video editor 122. Display 118 may be used to display the GUI of digital video editor 122. NIC 120 may be used to communicate with other computing devices over a network 106. A user 126 at computing device 102 may use digital video editor 122 to share a digital video with a user 128 at a computing device 104 through a social media service 130 over network 106.

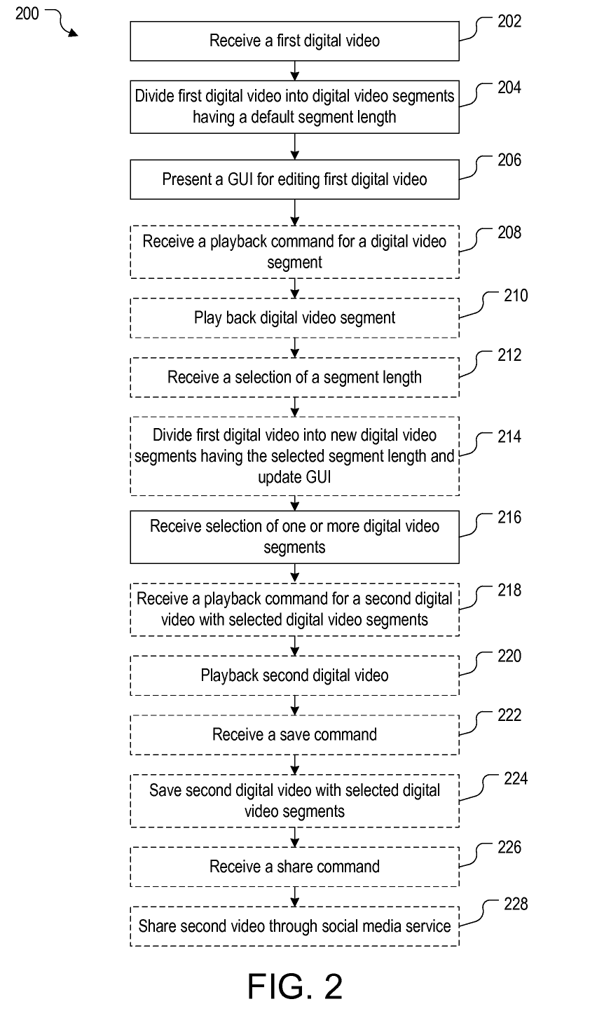

FIG. 2 is a flowchart of a method 200 for a digital video editor 122 to edit digital videos in one or more embodiments of the present disclosure. Method 200 may be implemented by processor 108 (FIG. 1) executing the code for digital video editor 122 (FIG. 1). Method 200 may include one or more operations, functions, or actions illustrated by one or more blocks. Although the blocks are illustrated in sequential orders, these blocks may also be performed in parallel, or in a different order than those described herein. Also, the various blocks may be combined into fewer blocks, divided into additional blocks, or eliminated based upon the desired implementation. Method 200 may begin in block 202.

In block 202, processor 108 receives a first digital video. The first digital video may be received from network 106 (FIG. 1), nonvolatile memory 112 (FIG. 1), or camera 114 (FIG. 1). Block 202 may be followed by block 204.

In block 204, processor 108 divides the first digital video into a default total number of digital video segments or digital video segments having a default segment length. Processor 108 may divide the first digital video into physical or logical digital video segments. Physical digital video segments are physical files created by processor 108 from the first digital video. Virtual digital video segments are logical files created by processor 108 with a data structure that records their time boundaries in the first digital video. Block 204 may be followed by block 206.

In block 206, processor 108 presents a GUI for editing the first digital video.

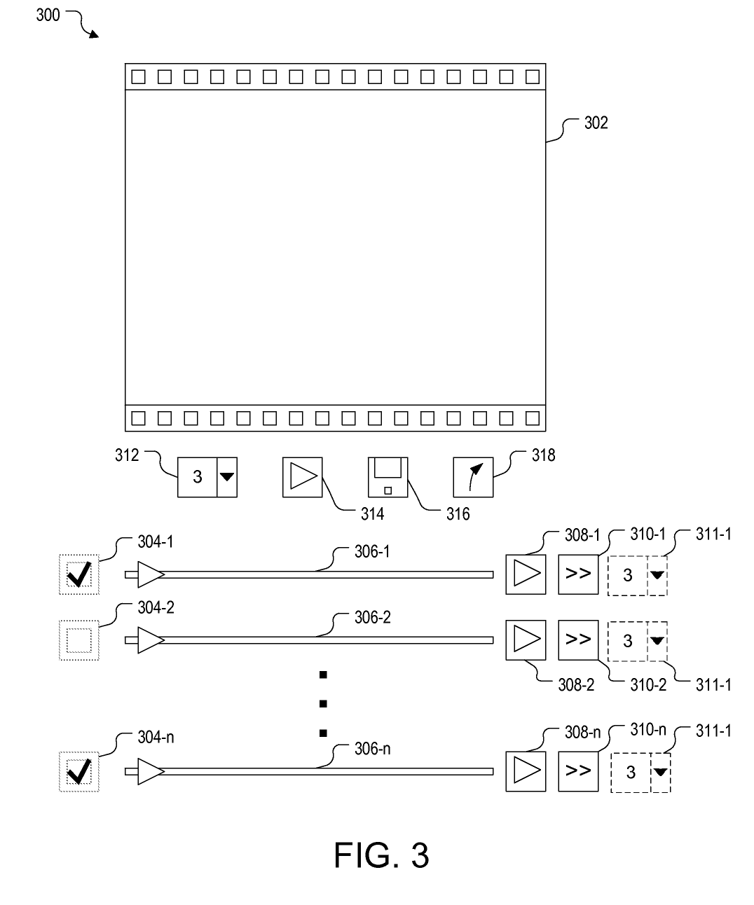

FIG. 3 shows a GUI 300 for digital video editor 122 in examples of the present disclosure. GUI 300 includes a playback area 302 to play back a digital video segment from the first digital video or selected digital video segments that form a second digital video. For each digital video segment, GUI 300 includes a checkbox to select the digital video segment to be included in the second digital video, and playback controls to playback the digital video segment in playback area 302. For example, GUI 300 includes checkboxes 304-1, 304-2 . . . 304-n (collectively as “checkboxes 304” or individually as a generic “checkbox 304”), position sliders 306-1, 306-2 . . . 306-n (collectively as “position sliders 306” or individually as a generic “position slider 306”), play button 308-1, 308-2 . . . 308-n (collectively as “play buttons 308” or individually as a generic “play button 308”), and fast forward buttons 310-1, 310-2 . . . 310-n (collectively as “fast forward buttons 310” or individually as a generic “fast forward button 310”) for digital video segments 1 through n, respectively. Instead of checkboxes 304, radio boxes or toggles may be used to select digital video segments. GUI 300 includes a drop-down list 312 to select a segment length, a play button 314 to play back the second digital video including the selected digital video segments in playback area 302, a save button 316 to save the second digital video, and a share button 318 to share the second digital video through a social media service. Instead of drop-down list 312, a list box or a text box may be used to set the segment length.

Referring back to FIG. 2, block 206 may be followed by optional block 208.

In optional block 208, processor 108 receives a user input to playback a digital video segment. For example, user 126 selects play button 308 (FIG. 3) to play a digital video segment. Optional block 208 may be followed by optional block 210.

In optional block 210, processor 108 plays back the corresponding digital video segment. As described above, the digital video segments may be physical or logical. When the digital video segments are physical, processor 108 plays back a physical file for the digital video segment. When the digital video segments are logical, processor 108 plays back a portion of the first digital video based on time boundaries of the digital video segment. Optional blocks 208 and 210 may be repeated to play back additional digital video segments. Furthermore position slider 306 and fast forward button 310 (FIG. 3) may also be used during the playback. Optional block 210 may be followed by optional block 212.

In optional block 212, processor 108 receives a selection of the total segment numbers or the segment length. For example, the user selects a total segment number or a segment length from drop-down list 312 (FIG. 3). Optional block 212 may be followed by optional block 214.

In optional block 214, processor 108 divides the first digital video into the selected total segment number of new digital video segments or new digital video segments having the selected segment length, and updates GUI 300 (FIG. 3) with the new digital video segments. For example, when the total segment number is decreased or the segment length is increased, processor 108 updates GUI 300 with a lesser number of checkboxes and playback controls for the new digital video segments. Conversely when the total segment number is increased or the segment length is decreased, processor 108 updates GUI 300 with a greater number of checkboxes and playback controls for the new digital video segments.

As described above, the same segment length may be applied to all the digital video segments. In some examples, different segment lengths may be applied to different digital video segments. For example, the digital video segments may be provided with segment length drop-down lists 311-1, 311-2 . . . 311-n (FIG. 3) for the user to individually tune the segment lengths of the digital video segments. When the segment length of a digital video segment is adjusted, processor 108 may automatically adjust the segment length of the subsequent digital video segment.

Optional block 214 may be followed by block 216.

In block 216, processor 108 receives one or more selections of one or more digital video segments to be included in the second digital video. For example, user 126 selects the checkboxes 304 (FIG. 3) corresponding to the desired digital video segments. Block 216 may be followed by optional block 218.

In optional block 218, processor 108 receives a user input to playback the second digital video with the selected digital video segments. For example, user 126 selects play button 314 (FIG. 3) to play the second digital video in playback area 302. Optional block 218 may be followed by optional block 220.

In optional block 220, processor 108 plays back the second digital video with the selected digital video segments in playback area 302. As described above, the digital video segments may be physical or logical. When the digital video segments are physical, processor 108 plays back the physical files of the selected digital video segments. When the digital video segments are logical, processor 108 plays back portions of the first digital video based on time boundaries of the selected digital video segments. Optional block 220 may be followed by optional block 222.

In optional block 222, processor 108 receives a user input to save command the second digital video with the selected digital video segments. For example, user 126 selects save button 316 (FIG. 3) to save the second digital video. Optional block 222 may be followed by optional block 224.

In optional block 224, processor 108 saves the second digital video with the selected digital video segments. As described above, the digital video segments may be physical or logical. When the digital video segments are physical, processor 108 may combine physical files of the selected digital video segments into the second digital video. When the digital video segments are logical, processor 108 may remove the unselected digital video segments from the first digital video based on time boundaries of the unselected digital video segments and save it as the second digital video. Optional block 224 may be followed by optional block 226.

In optional block 226, processor 108 receives a user input to share the second digital video. For example, user 126 selects share button 318 (FIG. 3) to share the second digital video. Sharing the second digital video may also cause the second digital video to be saved. Optional block 226 may be followed by block 228.

In optional block 228, processor 108 shares the second digital video through a social media service. For example, processor 108 sends the second digital video over computer network 106 (FIG. 1) to social media service 130 (FIG. 1) to share the second digital video with another user 128 (FIG. 1) on computing device 104 (FIG. 1).

Various other adaptations and combinations of features of the embodiments disclosed are within the scope of the present disclosure. Numerous embodiments are encompassed by the following claims.

What is claimed is:

1. A method to edit digital videos, comprising:
dividing a first digital video into digital video segments;
presenting a graphical user interface to select the digital video segments;
receiving one or more selections of one or more of the digital video segments through the graphical user interface; and
saving a second digital video with the selected digital video segments.

2. The method of claim 1, wherein the graphical user interface comprises checkboxes, radio boxes, or toggles to select the segments.

3. The method of claim 1, further comprising:
presenting the graphical user interface to set a total segment number or a segment length of the digital video segments; and
dividing the first digital video into new digital video segments in response to a user input for the total segment number or the segment length received through the graphical user interface.

4. The method of claim 3, wherein the graphical user interface further comprises a drop-down list, a list box, or a text box to set the total segment number or the segment length.

5. The method of claim 1, further comprising:
presenting the graphical user interface to playback the second digital video; and
playing back the second digital video in response to a user input to playback the second digital video received through the graphical user interface.

6. The method of claim 5, wherein the graphical user interface comprises a play button, a fast-forward button, and a position slider.

7. The method of claim 1, further comprising:
presenting the graphical user interface to playback the digital video segments; and
playing back a digital video segment in response to a user input to playback the digital video segment received through the graphical user interface.

8. The method of claim 7, wherein the graphical user interface comprises a play button, a fast-forward button, and a position slider.

9. The method of claim 1, further comprising:
presenting the graphical user interface to share the second digital video through a social media service; and
transmitting the second digital video over a computer network to the social media service in response to a user input to share the second digital video received through the graphical user interface.

10. The method of claim 9, wherein the graphical user interface comprises a button to share the second digital video.

11. A non-transitory computer-readable medium comprising instructions for a processor to edit digital videos, the instructions comprising:
dividing a first digital video into digital video segments;
presenting a graphical user interface to select the digital video segments;
receiving one or more selections of one or more of the digital video segments through the graphical user interface; and
saving a second digital video with the selected digital video segments.

12. The non-transitory computer-readable medium of claim 11, wherein the user interface comprises checkboxes, radio boxes, or toggles to select the digital video segments.

13. The non-transitory computer-readable medium of claim 11, wherein the instructions further comprises:
presenting the graphical user interface to set a total segment number or a segment length of the digital video segments; and
dividing the first digital video into new digital video segments in response to a first user input for the total segment number or the segment length received through the graphical user interface.

14. The non-transitory computer-readable medium of claim 13, wherein the user interface further comprises a drop-down list or a list box to set the total segment number or the segment length.

15. The non-transitory computer-readable medium of claim 13, wherein the instructions further comprises:
presenting the graphical user interface to playback the second digital video; and
playing back the second digital video in response to a second user input to playback the second digital video received through the graphical user interface.

16. The non-transitory computer-readable medium of claim 15, wherein the graphical user interface comprises a play button, a fast-forward button, and a position slider.

17. The non-transitory computer-readable medium of claim 15, wherein the instructions further comprises:
presenting the graphical user interface to playback the digital video segments; and
playing back a digital video segment in response to a third user input to playback the digital video segment received through the graphical user interface.

18. The non-transitory computer-readable medium of claim 17, wherein the graphical user interface comprises a play button, a fast-forward button, and a position slider.

19. The non-transitory computer-readable medium of claim 17, wherein the instructions further comprises:
presenting the graphical user interface to share the second digital video through a social media service; and
transmitting the second digital video over a computer network to the social media service in response to a fourth user input to share the second digital video received through the graphical user interface.

20. The non-transitory computer-readable medium of claim 19, wherein the graphical user interface comprises a button to share the second digital video.
